(19) United States
(12) Patent Application Publication
(10) Pub. No.: US 2013/0169448 A1
(43) Pub. Date: Jul. 4, 2013

(54) MONITORING THE OPERATION OF A SUBSEA HYDROCARBON PRODUCTION CONTROL SYSTEM

(71) Applicants: Naresh Kunchakoori, Ameenapur (IN); Gopalakrishna Gudivada, Madhapur (IN)

(72) Inventors: Naresh Kunchakoori, Ameenapur (IN); Gopalakrishna Gudivada, Madhapur (IN)

(21) Appl. No.: 13/339,632

(22) Filed: Dec. 29, 2011

(51) Int. Cl. H04B 13/02

(52) U.S. Cl. 340/850

(57) ABSTRACT

A method of monitoring the operation of a subsea hydrocarbon production control system is provided. The method comprises monitoring at least one subsea device of the system, and, if the at least one subsea device fails to a fail-safe condition, sending a wireless indication that the at least one subsea device has failed to a fail-safe condition.

### BACKGROUND OF THE INVENTION

1. Field of the Invention

Embodiments of the present invention relate to monitoring the operation of a subsea hydrocarbon production control system.

2. Background of the Invention

A shutdown philosophy is employed in the design of production control systems for subsea oil and gas wells, to ensure the protection of personnel, environment and equipment from the consequences that may occur as a result of abnormal operational conditions, accidental release of hydrocarbons or other accidents. This usually entails the inclusion of production shutdown and emergency shutdown mechanisms being built into the system, so that the system fails to a safe condition.

In this respect it is important that the status of all subsea valves and their actuators, which form part of the production control system, are known at all times but, more essentially, after a fail-safe shutdown has occurred. However, situations can arise where this information is not available and where this knowledge is critical for eliminating the problem (such as oil spilling out of a well or pipeline). Recent events in the Gulf of Mexico have demonstrated this need.

Examples of fail-safe shutdowns resulting from subsea failures, where relevant status information cannot be obtained using the existing system functionality, are those which occur between a well Christmas tree and the power distribution and protection module (PDPM) which is installed subsea and is the main subsea interface with Christmas trees providing electrical power, hydraulic power and communications to each Christmas tree. Such failures include failure in communications between a Christmas tree and the PDPM; failure of the power line between a Christmas tree and PDPM; failure in the hydraulic line between a Christmas tree and the PDPM; and a combination of the above three failures. Other situations are possible. A failure in any of these links will result in no information being available topside on valve status.

In all these situations, flow control valves and protective valves go into a fail-safe condition, but there is no means of verifying the actual status of the valves because communication is not possible between the Christmas tree concerned and the PDPM. A means of overcoming this would significantly improve the functional safety of hydrocarbon production control systems.

As prior art, there may be mentioned WO 2009/122168; the Internet article “To the last drop”, pages 63-66, XP002532134 (www.abb.com/abbreview); WO 2005/078233; US 2006/0159524 A1; US 2003/0098799 A1; US 2004/0124994 A1; U.S. Pat. No. 6,798,338; GB-A-2 377 131; WO 2006/134331; GB-A-2 163 029; and Ram Somaraju, et al, “Frequency, Temperature and Salinity Variation of the Permittivity of Seawater”, Vol. 54, No. 11, November 2006, IEEE Transactions on Antennas and Propagation, IEEEE Service Center, Piscataway, N.J., US, pages 3441-3448, XP011150333 ISSN: 0018-926X.

### BRIEF SUMMARY OF THE INVENTION

According to an embodiment of the present invention, there is provided a method of monitoring the operation of a subsea hydrocarbon production control system. The method comprises monitoring at least one subsea device of the system, and, if the at least one subsea device fails to a fail-safe condition, sending a wireless indication that the at least one subsea device has failed to a fail-safe condition.

According to another embodiment of the present invention, there is provided a method of monitoring the operation of a subsea hydrocarbon production control system. The method comprises monitoring at least one subsea device of the system, and, if the at least one subsea device fails to a fail-safe condition, sending a wireless indication that the at least one subsea device has failed to a fail-safe condition, wherein the indication is sent to a fail-safe monitoring unit and is sent from a fail-safe monitoring module at a tree of the system with which the at least one subsea device is associated.

According to another embodiment of the present invention, there is provided a subsea hydrocarbon production control system comprising a fail-safe monitoring unit configured to monitor at least one subsea device of the system and a fail-safe monitoring module configured to send a wireless indication if the at least one subsea device fails to a fail-safe condition.

### BRIEF DESCRIPTION OF THE DRAWINGS

FIG. 1 is a schematic diagram of an embodiment of the invention; and

FIG. 2 is a block diagram of a modification which can be made to FIG. 1.

### DETAILED DESCRIPTION OF THE INVENTION

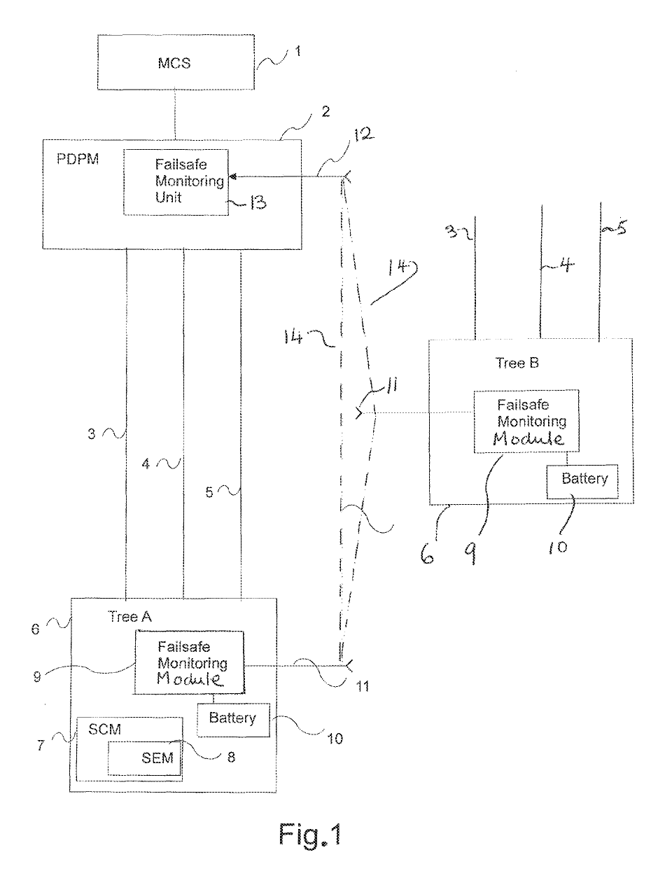

FIG. 1 illustrates an embodiment of the invention. In a conventional production control system, a master control station (MCS) 1, installed topside, provides the operator interface with subsea equipment and displays the current state of the various equipments and sensor information, enabling the operator to control the system. The MCS 1 collates data such as the operational state of all subsea valves and data relating to the state of production fluids across an entire oilfield. The MCS 1 interfaces with the subsea installed power distribution and protection module (PDPM) 2 which feeds electric power on lines 3, hydraulic power on lines 4, and communication on a line 5 to a plurality of Christmas trees 6, only two (A and B) being shown.

Each Christmas tree 6 includes a subsea control module (SCM) 7 which controls all the Christmas tree processes by providing hydraulic power to actuate valves mounted on the Christmas tree and at the wellhead. It also receives process instrumentation signals from sensors mounted on the Christmas tree and at the wellhead. These are received and processed in a subsea electronics module (SEM) 8 housed within the SCM 7 and communicated via the system communication link to the PDPM 2, and then topside. Failure of the communications link between a Christmas tree 6 and the PDPM 2 will result in no valve and other status data being available from that tree.

In accordance with an embodiment of the invention, a dedicated fail-safe monitoring module 9 is at each tree 6, which module provides data on the health of the valves, as well as their actuating mechanisms. The module 9 includes its own interfacing, signal conditioning and processing and includes its own dedicated sensors. A back-up battery 10 is built-in so that the module can still operate in the event of electrical power failure. Health monitoring of the module 9 would form part of the normal equipment condition monitoring checks and the battery would be kept charged from the normal power supplies.

The production control system is provided with its own subsea wireless communication arrangement to communicate with the PDPM 2, so that in the event of a normal communication channel failure (copper wire, communications-on-power or fibre-optic) it has an alternative independent communication link. More particularly, at each tree 6, there is an RF antenna 11 for sending data to an RF antenna 12 at the PDPM 2 and thence to a fail-safe monitoring unit 13 in the PDPM 2. Thus, each Christmas tree 6 in the overall production well complex has its own SCM 7 and fail-safe monitoring module 9 with a subsea wireless link 14. This enables individual Christmas trees to communicate with the PDPM and each other, providing alternative routes for valve and other status information to reach topside.

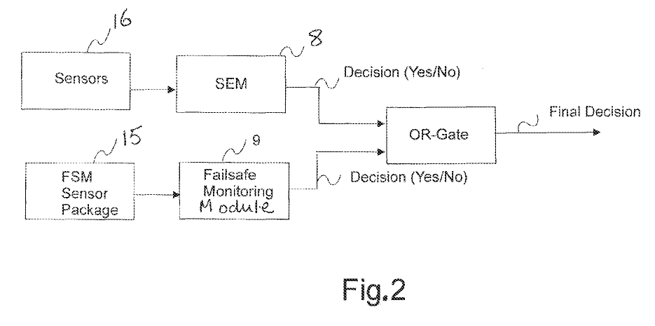

FIG. 2 illustrates an example of a configuration in which the fail-safe monitoring module 9 with its fail-safe monitoring (FSM) dedicated sensor package 15 is used in conjunction with the SEM 8 and its sensor package 16. When the sensor signals feeding the SEM 8 result in it triggering the fail-safe mechanism, a check can be made against the output from the fail-safe monitoring module 9 to see if this has also triggered a fail-safe mechanism as a result of the data from its dedicated sensor package. A fail-safe mechanism gets executed if either or both the SEM and the fail-safe monitoring system takes the decision to trigger a fail-safe mechanism. This also adds redundancy to the system.

Embodiments of the invention can utilize a wireless communication system between topside and subsurface equipment that forms part of the latest hydrocarbon production control system.

There is no need to rely on hardwired communication systems using communications-on-power techniques or separate wired communication cables.

The availability of subsea status information can provide immediate confirmation of a fail-safe situation and enable a rapid response to be achieved to a developing situation.

A rapid response to dangerous situations can save lives, significantly reduce environmental pollution and reduce the cost of rectifying situations which arise.

An embodiment of the invention to be described below entails including a separate, independent, dedicated, health monitoring module on a Christmas tree, for monitoring the status of all actuators and valves installed on the Christmas tree and wellhead. The system has its own dedicated subsea wireless communication link capable of communicating information to a wireless receiving system on the PDPM and on other Christmas trees. Thus, in the event of failure of the normal communication links, the wireless channel is available. The module is provided with its own battery back-up to provide power in the event of power supply failure. The module sits alongside the normal process and control equipment in the Christmas tree mounted subsea control module (SCM) and can also be used to enhance the fail-safe decision making process in the SCM, by providing additional confirmation of the state of actuators and valves. If a shutdown should occur, but an indication that a device has gone to a fail-safe condition is not received, then this is an indication of a problem.

The module can also form part of the normal decision making process by adding some intelligence to process the critical data which is related to a fail-safe condition.

Addition of the module also adds redundancy to the system.

What is claimed is:

1. A method of monitoring the operation of a subsea hydrocarbon production control system, the method comprising monitoring at least one subsea device of the system, and, if the at least one subsea device fails to a fail-safe condition, sending a wireless indication that the at least one subsea device has failed to a fail-safe condition.

2. The method according to claim 1, wherein the indication is sent to a fail-safe monitoring unit.

3. The method according to claim 2, wherein the fail-safe monitoring unit is a subsea unit.

4. The method according to claim 3, wherein the subsea unit is in a subsea power distribution and protection module.

5. The method according to claim 1, wherein the at least one subsea device comprises at least one of a valve and an actuating mechanism for a valve.

6. The method according to claim 1, wherein the indication is sent from a fail-safe monitoring module at a tree of the system with which the at least one device is associated.

7. The method according to claim 6, wherein the system comprises at least one further tree from which, if at least one subsea device associated with the further tree fails to a fail-safe condition, a wireless indication that the at least one subsea device associated with the further tree has failed to a fail-safe condition is sent from a fail-safe monitoring module of the further tree.

8. A method of monitoring the operation of a subsea hydrocarbon production control system, the method comprising monitoring at least one subsea device of the system, and, if the at least one subsea device fails to a fail-safe condition, sending a wireless indication that the at least one subsea device has failed to a fail-safe condition, wherein the indication is sent to a fail-safe monitoring unit and is sent from a fail-safe monitoring module at a tree of the system with which the at least one subsea device is associated.

9. The method according to claim 8, wherein the fail-safe monitoring unit is a subsea unit.

10. The method according to claim 9, wherein the subsea unit is in a subsea power distribution and protection module.

11. The method according to claim 8, wherein the at least one subsea device comprises at least one of a valve and an actuating mechanism for a valve.

12. The method according to claim 11, wherein the system comprises at least one further tree from which, if at least one subsea device associated with the further tree fails to a fail-safe condition, a wireless indication that the at least one subsea device associated with the further tree has failed to a fail-safe condition is sent from a fail-safe monitoring module of the further tree.

13. A subsea hydrocarbon production control system comprising a fail-safe monitoring unit configured to monitor at least one subsea device of the system and a fail-safe monitoring module configured to send a wireless indication if the at least one subsea device fails to a fail-safe condition.

14. The system according to claim 13, wherein the indication is sent to the fail-safe monitoring unit.

15. The system according to claim 14, wherein the fail-safe monitoring unit is a subsea unit.

16. The system according to claim 15, wherein the subsea unit is in a subsea power distribution and protection module.

17. The system according to claim 13, wherein the at least one subsea device comprises at least one of a valve and an actuating mechanism for a valve.

18. The system according to claim 13, wherein the indication is sent from a fail-safe monitoring module at a tree of the system with which the at least one subsea device is associated.

19. The system according to claim 18, wherein the system comprises at least one further tree from which, if at least one subsea device associated with the further tree fails to a fail-safe condition, a wireless indication that the at least one subsea device associated with the further tree has failed to a fail-safe condition is sent from the fail-safe monitoring module of the further tree.

20. The system according to claim 13, wherein, the indication is sent to the fail-safe monitoring unit and is sent from the fail-safe monitoring module at a tree of the system with which the at least one subsea device is associated.
